(19) United States
(12) Patent Application Publication
(10) Pub. No.: US 2011/0296969 A1
(43) Pub. Date: Dec. 8, 2011

(54) Multiple punch unit for punch presses

(75) Inventor: Eugenio Lenzotti, Formigine (IT)

(73) Assignee: EUROMAC S.P.A., Formigine (IT)

(21) Appl. No.: 13/151,095

(22) Filed: Jun. 1, 2011

(30) Foreign Application Priority Data
Jun. 4, 2010 (IT) MO2010A000163

(51) Int. Cl. B26D 7/26; B26F 1/04; B26D 5/08

(52) U.S. Cl. 83/563; 83/549; 83/640; 83/698.21

(57) ABSTRACT

A multiple punch apparatus for punch presses having a provision for preventing undesired damage to a work-piece includes a housing having a plurality of separate punches that include at least one inactive punch and one active punch, each inactive punch being supported in an elevated position by retention magnet means having flux lines oriented to extend into at least each inactive punch when the active punch is in a position in which it is driven into engagement with a work-piece, whereby each inactive punch is magnetically supported to prevent any unintended contact with the work-piece.

### FIELD OF THE INVENTION

The invention relates to the field of punches and dies, and more particularly to a multiple punch and multiple die apparatus suitable for use in a punch press for punching or forming sheet materials.

### BACKGROUND ART

Multiple punch apparatus of the type that is used in automatic, computer-driven high-speed punching presses, are disclosed in U.S. Pat. Nos. 7,032,812; 6,675,688; 6,279,445; 6,074,330; 5,848,563; 5,062,337; 5,048,385; 3,527,130; as well as Ser. No. 11/583,530, filed on 19 Oct. 2006.

In a multiple punch apparatus of this type, a common stripping spring or spring assembly is typically provided, which acts upon a single punch carrier that supports and raises all the punches together.

In operation, the hammer strikes on a selected punch (referred to as active punch) to guide it through a work-piece, such as a section of a metal sheet.

Then, the punch is pulled out of the material sheet, whereupon the other inactive pinches are raised and lowered.

Anyway, in the above mentioned punches, the inactive punches may be often lowered to such an extent as to hit the work-piece with enough force to damage the work-piece surface.

If the work-piece is relatively thin, delicate or highly polished, or otherwise easily subjected or exhibiting scratches, dents or other imperfections, it will be desirable to find a way to prevent inactive punches from contacting the work-piece, and from damaging a delicate or highly polished surface.

An undesired damage to the work-piece may be caused by the weight or inertia of one or more of the inactive punches and may be aggravated by the impact force distributed throughout the unit by the fracture caused in the material sheet during punching.

Many attempts have been made, in the development of the invention, to find a feasible way to avoid such damages by inactive punches.

Nevertheless, no thoroughly effective method has been found.

For example, there has been an attempt to provide a horizontal plate to keep the inactive punches raised.

A friction element has also been provided, for preventing them to slide on the work-piece.

In order to ensure effectiveness, the device must prevent any undesired contact between the inactive punches and the work-piece, while avoiding any interference with the action of the active punch during the punching steps.

The prior art solutions suffer from a number of defects, insufficient reliability and accuracy, and involve the use of mechanically complex mechanisms and unacceptably weak components.

Furthermore, the inactive punches are required to be supported at a definite distance from the work-piece.

This is a complex requirement, as the space between the tip of the punch and the metal sheet may be very small, e.g. a fraction of a millimeter, and shall be sufficiently reliable for proper, positive operation after millions of punching cycles, and for sufficiently safe support of the punches at the top, to avoid release thereof during the violent punching load of a strong fracture.

The highly disruptive load required in these friction retention methods is inadequate and a single punch retention mechanism is often unusable due to space and cost limitations.

Magnets have been used for supporting flat die platforms. For example, according to U.S. Pat. No. 3,517,597, many magnets are provided in the die platform, but the platform is not movable aside to a non-operating position while another platform is shifted into place nor is damage caused by an inactive punch.

U.S. Pat. No. 3,211,035 discloses a single punch, which is rigidly supported in a cavity of a punch carrier by a screw arrangement.

The lower end of an annular magnet contacts the punch carrier but the magnet does not act upon the punch.

Also, with the single punch as disclosed, there are no inactive punches, no damage is thus caused by inactive punches, and no punches are moved between active or inactive positions.

U.S. Pat. No. 5,138,919 shows another single punch, in which a rubber stripper is provided, having an annular magnetic disk bonded to its upper end for supporting the stripper in its position above the punch carrier.

Since a single punch is disclosed, no need arises for preventing inactive punches from damaging the work-piece, for avoiding actuation of the magnet on the punch instead of the punch carrier.

### SUMMARY OF THE INVENTION

In the light of these and other drawbacks of the prior art, one object of the present invention is to provide a reliable means for preventing undesired contact between inactive punches and a work-piece susceptible of being damaged.

Another object of the invention is to prevent damages caused to a work-piece by an inactive punch in a punch unit under jolts, vibrations and impacts that occur when the punch unit is operated and quickly indexed between successive punching operations.

Yet another object of the invention is to prevent any inactive punch in a multiple punch unit from slipping, incising or otherwise damaging or spoiling a work-piece, without interfering with the punching operations performed by the active punch, as it is driven through the work-piece.

In one aspect, the present invention relates to a multiple punch unit for punch presses that is configured to prevent unintended damage to a work-piece and that includes a housing having a plurality of separate punches, which include at least an inactive punch and at least an active punch. Each inactive punch is supported in an elevated position by retention magnet means that have flux lines positioned to extend into each inactive punch when the active punch is positioned for being driven into engagement with a work-piece.

In another aspect, the present invention relates to multiple punch units that may have six or more punches arranged in a circle, which are not rigidly fixed to the punch carriers by screw arrangements. Each punch is allowed to be horizontally indexed below a punch striker where it is free to be driven to contact with the work-piece.

### BRIEF DESCRIPTION OF THE DRAWINGS

Further characteristics and advantages of the invention will be more apparent from the detailed description of one preferred, non-exclusive embodiment of a multiple punch unit for punch presses, which is described by way of illustration and without limitation with the help of the annexed drawings, in which:

FIG. 1 is a perspective view of an embodiment of a multiple punch and die unit according to the invention, which shows the damages that can be prevented by use of the invention;

FIG. 2 is a vertically sectional view, as taken along the line 2-2 of FIG. 1, which shows the punch striker in a raised position;

FIG. 3 is a view similar to FIG. 2, in a lowered position that shows a punch extending into the work-piece at the end of a punching operation;

FIG. 4 is an enlarged exploded perspective bottom view of a magnet supporting carousel and a punch striker in its retracted position;

FIG. 5 is a vertically sectional view taken along lines 5-5 of FIG. 4;

FIG. 5A is a perspective top view of a punch carrier, showing apertures arranged in a circle for receiving punches;

FIGS. 6 to 8 are sequential side elevational diagrams showing the rotation of magnets relative to non-rotating punches; and

FIG. 9 is a diagram that shows the magnetic flux lines extending through the magnet and the punch.

### DETAILED DESCRIPTION OF A PREFERRED EMBODIMENT

Multiple punch units are known per se, as shown in the above patents.

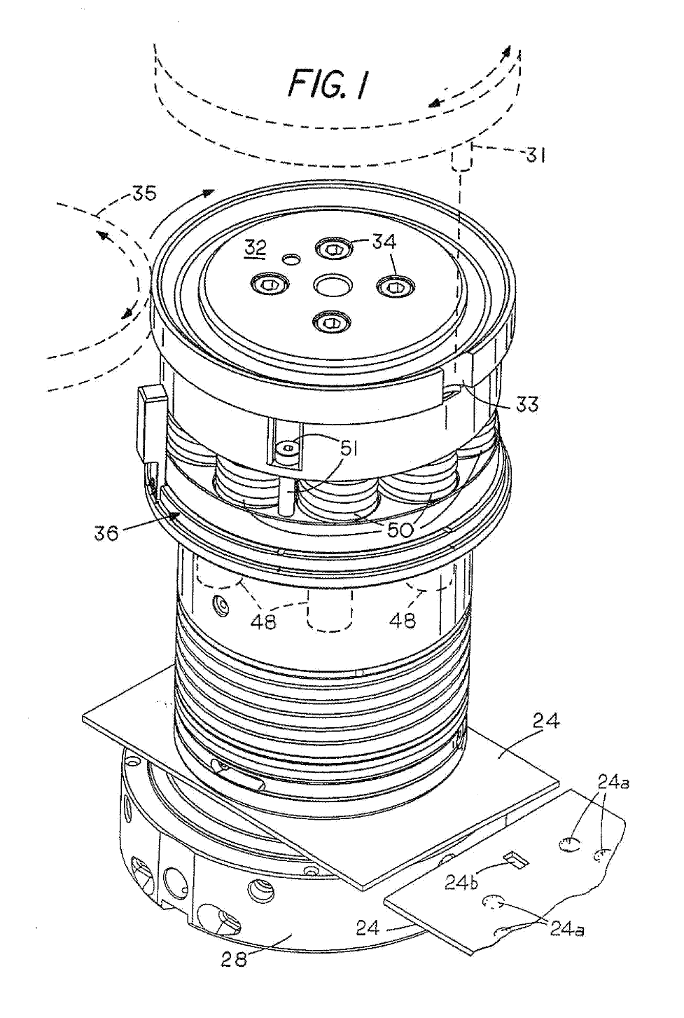

While the invention finds application in multiple punch units in general, such as those listed herein, it will be exemplarily described in the multiple punch units as shown in the figures, i.e. FIGS. 1 to 8.

FIGS. 1 to 3 show a multiple punch apparatus 10 having six punches 12 mounted in circular arrangement to slide along a vertical center axis 23 in apertures formed in circular arrangement into a punch carrier 14, which is in turn slidably mounted to axially move within a vertical hole 16a of a tubular guide seat 16.

A striking head 12c, whose diameter is larger than that of its shaft, is provided at the upper end of each punch 12, and rests on the punch carrier 14, except during the punching steps, when the punch carrier 14 is raised with the punch striker 22, thereby leaving a gap “G”.

Therefore, the punch carrier 14 raises the punches 12 by engaging the head 12c with a sufficient force, possibly of some tons, to remove the punch tip 12b from the work-piece.

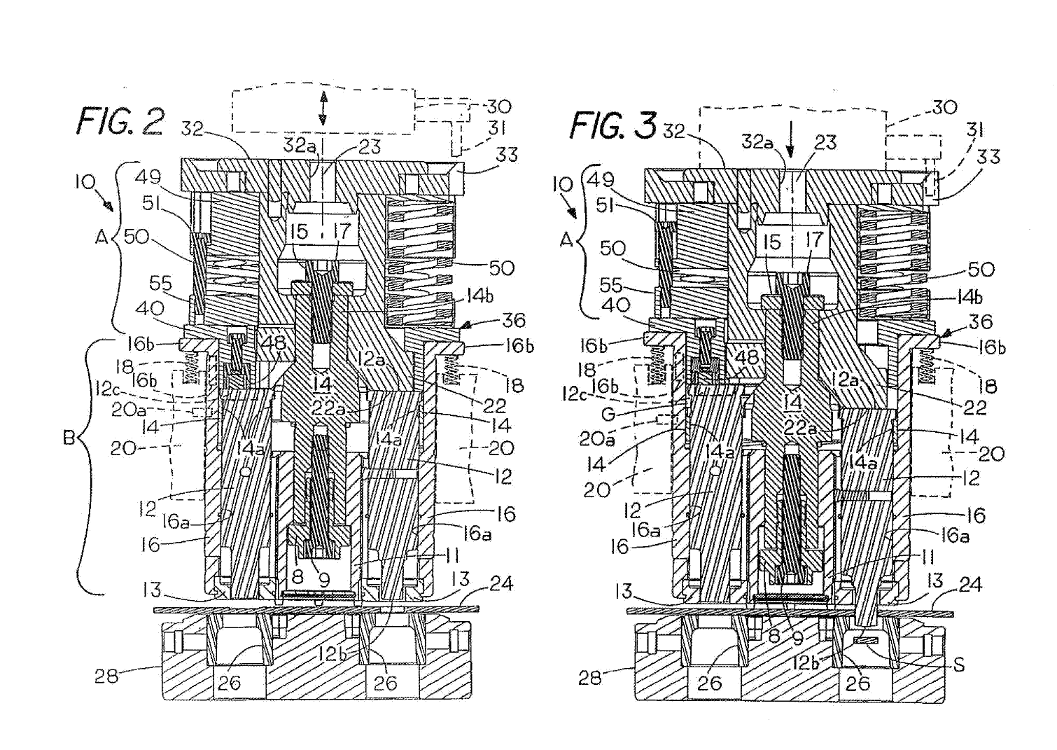

A laterally extending circular flange 16b is provided at the upper end of the guide seat, and is supported on raising springs, two of which are shown in FIG. 2, as components of a turret 20 of a punch press which is not part of this invention, where the punching unit 10 of the present invention is held during operation.

The guide seat 16 is locked against axial rotation, for instance, by a pin 20a (FIG. 2).

A punch striker 22 is slidably mounted in the unit 10 above the punches 12 and is quickly rotated, i.e. indexed, about the axis 23, for sequentially driving downwards each of the punches 12, which is selected through the apertures 14a and the punch carrier 14 and projects out of the bottom of the guide seat 16, in contact with a work-piece 24, i.e. typically a metal sheet work-piece, as shown in FIG. 3.

The punch carrier 14 comprises a centrally positioned, axially aligned shaft 14b whose upper end extends upwards through an axial hole, into the punch striker 22 and is held in its seat by a spacer 15 and a bolt 17 which is accessible through the hole 32a of the cover 32 of the striker.

The metal sheet work-piece 24 is conventionally supported by dies 26, each of the latter being supported in aligned relation with one of the punches 12 by a die support 28 of known construction.

An annular stripper 13, as provided in prior art construction, surrounds the tip 12b of each of the punches, and is supported in its position in any known manner, such as by means of a stripper retainer 11, which is attached to the bottom of the punch carrier 14 by means of external bolts, not shown.

During operation, the punch striker 22 is driven downwards by a hammer 30 of a punch press, which is shown in its return position in FIG. 2 and in its operating position in FIG. 3 while it is in contact with the cover 32 of the punch striker that is fastened to the top of the punching hammer 22 by bolts 34.

FIG. 1 also shows a damage, with the surface of the work-piece designated by numeral 24a spoiled by the tip of an inactive punch, which accidentally moved downwards to such an extent as to contact one of the work-pieces 24 when punching a hole 24b.

The multiple punch apparatus 10, shortly referred to hereinafter as apparatus 10 or multiple punch unit 10, as described above is substantially similar, in terms of operation, to general, commercially available multiple punch units as disclosed in the above mentioned patents and in pending patent application Ser. No. 11/573,439, by the owner hereof.

However, a magnet carousel 36 is held within the apparatus 10 (FIGS. 2 to 5), and surrounds the lower end of the punching hammer 22, which has a hollow annular portion 38 and, laterally, a circular extension flange 40.

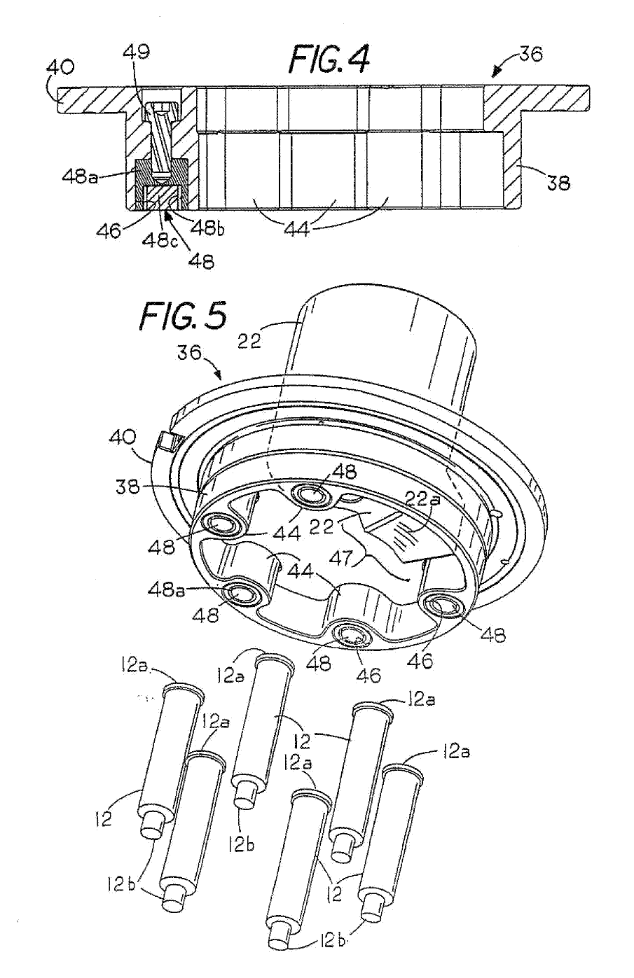

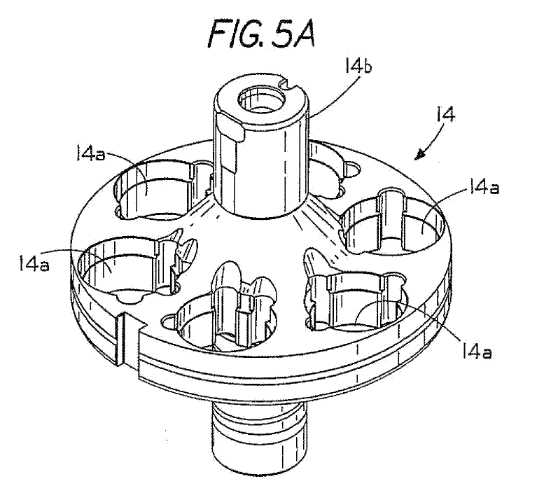

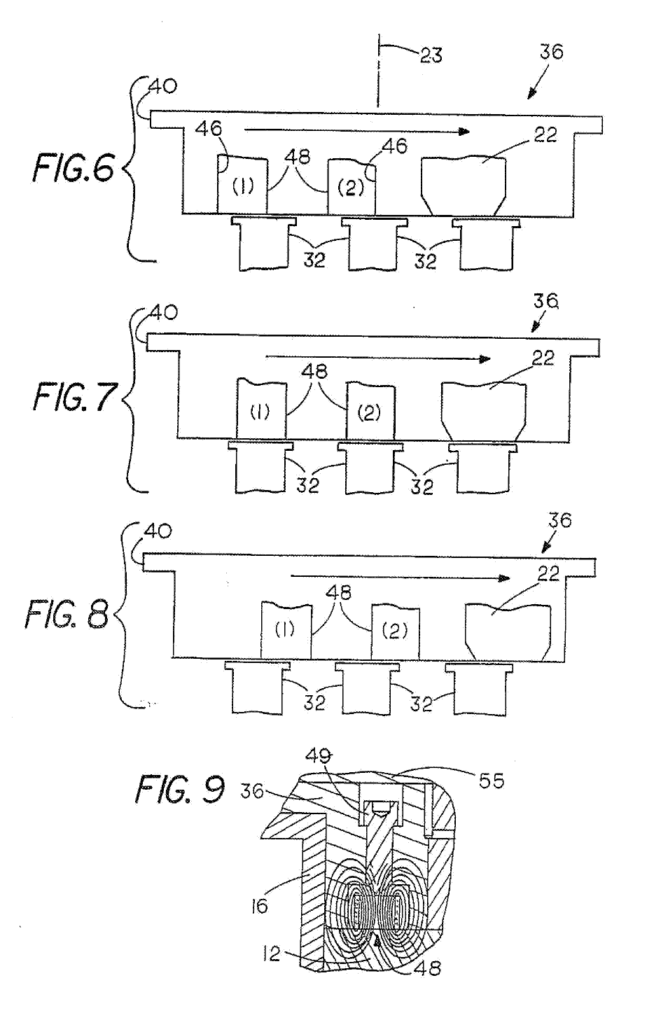

The magnet carousel 36 has a central passage 42 open at the top and the bottom, as clearly shown in FIG. 5, which is surrounded by a plurality of centrally projecting juts 44 (five, in this case), each containing a chamber opening 46 extending up and down (FIGS. 5 and 6) for a set of magnets 48 that, in this example, includes five magnets (FIG. 5).

A diastema 47 can be seen on the right side of FIG. 5, with one of the magnets 48 missing.

As better explained below, the magnets 48 are spaced at regular intervals, but a position is occupied at the center of the diastema 47 by the face 22a of the punch striker 22, which contacts a top surface 12a of the punch that has to be driven through the work-piece from time to time, as shown in FIG. 3.

FIGS. 1-3 show a plurality of stripping springs 50, including compression springs circumferentially arranged between the cover 32 of the punch striker and the flange 40 of the magnet carousel 36 to drive into upward operation the punch striker 22, the cover 32 of the punch striker, the punch carrier 14, during operation to retract the head 12a of the active punch from the work-piece 24 when the punching operation as shown in FIG. 3 has been completed.

The retracted or “up” position of the punch striker 22 and the cover 32 of the punch striker and the punch carrier 14 is restricted by the head of a flanged screw 8.

The upper ends of the springs 50 extend into the spring-holder 49.

A lower spring holder 55 supports the lower end of each spring 50.

As better shown in FIG. 3, when the active punch as shown on the right side of the figure is in its operating position, thereby forcing the section S of the work-piece 25, the inactive punches (FIG. 5) and the punch on the left side of FIG. 3 are all retained in a raised position by one of the sets of permanent magnets 48, each being aligned with one of the inactive punches but not with the active punch on the right side of FIG. 3, which is aligned under the operating face 22a of the punch striker 22 at the center of the diastema 47.

It should be noted, in FIGS. 3 and 6-8, that the upper half of the unit 10 designated by “A” (FIG. 2), which comprises the punch striker 22 and the magnetic magnet carousel 36, rotates as it is indexed through punching operations, e.g. by means of a pin 31 that is part of a punch press (as shown by broken lines), projecting into a slot 33 in the periphery of the cover 32 of the punch striker or, alternatively, by means of a gear 35, that is also part of the punch press, in which case the cover 32 of the punch striker has teeth (not shown) all around its periphery, engaging with the gear 35.

Anyway, the guide seat 16 as shown under B in FIG. 2, and the punches 12 are locked against rotation, in this case by the alignment pin 20a (FIGS. 2 and 3), which prevents rotation when it is mounted, as shown, in the turret of the punch press 20.

A comparison of FIGS. 6, 7, 8 will show that, since the magnet carousel 36 rotates about the vertical axis 23 during operation, the magnets 48 are moved from left to right in the figure, relative to the stationary punches 32, until each magnet 48 is aligned with one of the punches, as shown in FIG. 7. Then, the punch striker 22 will be aligned above the active punch 12 on the right side of FIG. 7, just before the punch striker is forced downwards by the hammer 30, thereby driving the tip of the punch 12b through the work-piece, as shown in FIG. 3.

The flange 40 at the top of the magnet carousel 36 has two purposes.

It acts as a retention member for the stripping springs 50 and is lubricated to provide an annular support to the top surface of the flange 16b at the top of the guide seat 16.

Therefore, the magnet carousel 36 with the magnet assembly 48 rotates through the various punch heads and sequentially applies a retention force to all inactive punches, when the multiple punch unit 10 is operating.

While the magnets may touch the punches, a small gap of at least a few hundredths of an inch is preferably provided between the punch head and the surface of the magnet in which one of the pole pieces is located.

A preferred magnet is a cylindrical permanent magnet made of neodymium-iron-boron alloy.

Referring to FIGS. 4, 5 and 9, a preferred embodiment of a set of magnets 48 is shown, which comprises a set of isolated magnets, having a cylindrical housing 48a with a downwardly open cylindrical pocket 48b containing a permanent magnet 48c located at the center, circumferentially spaced from the housing 48a by means of annular spacers 48d that include a non-ferromagnetic separator, e.g. air or another substance, for instance a non-magnetic metal such as aluminum, non-magnetic ceramic or a plastic resin, such as an insulating resin or a segment of a rigid plastic tube.

Epoxy resin and non-ferrous metals, such as brass, have been deemed to be adequate.

The housing is joined to the carousel by a bolt 49.

The magnet and the spacer 48d may be press-fit into the housing.

The permanent magnet is preferably a samarium-cobalt magnet, or a neodymium-iron-boron magnetic alloy, with the pole pieces at the top and the bottom, so that the flux lines have a cylindrical symmetry about a vertical axis, and extend into the punch 12 as shown in FIG. 9, as well as through the ferromagnetic housing 48a around the magnet, around the outer cylindrical portion of the housing 48a, surround the spacer 48d and come back to the top pole piece of the magnet 48c, which is essentially level with the bottom of the ferromagnetic housing 48a.

This provides a complete magnetic circuit, which exerts a very strong attraction on the impact surface 12a of each punch 12, except the one of the punch that is located below the operating face 22a of the punch striker 22.

The punches may actually touch the set of magnets 48a-48d or, if needed, they may be spaced a few hundredths of a millimeter from the surface, so that no physical contact occurs therebetween.

It was found that, with the flux lines perpendicular to the interface between the magnet and the punch, the magnetic force that attracts the punch upwards toward the magnets is stronger than the force required to laterally rotate the set of magnets 48 relative to the stationary punches.

As a result, the automatic rotary indexing motion of the magnets and the punch striker is not adversely affected thereby.

It was also found that, during operation, the set of magnets 48 also acts somewhat as a rotation preventing key, in the form of a stop that aligns the magnets with the inactive punches 12.

For operation of the multiple punch unit 10, the latter was installed in the upper turret 20 of a turret of a punch press of commercial type, and is aligned with a multiple die unit 28 in the lower turret of the punch press.

During operation, it will be seen that the sets of magnets 48 and the inactive punches 12 will be supported by the magnets 48 in a raised position, as shown in FIGS. 2 and 3, out of contact with the work-piece.

Tests conducted with the invention by simulating the current operating conditions show that the set of magnets 48 reliably support the inactive punches in position and prevent them from spoiling the work-piece 24, whether the punches physically contact the set of magnets or not.

The invention was also found to be reliably effective in spite of the presence of steel particles which are often found inside and around punch press systems.

Those tests also prove that the invention is highly effective with the thousands of existing commercially available punches, and that the magnets may be easily indexed from one punch to the other, assuming that the magnets move laterally from one punch to the next whereas the upper part A of the set 10 rotates between strokes of the punch striker 22.

In addition, the punches 12 are reliably supported even when the punch carrier 14 is lowered, as shown in FIG. 3, during a punching cycle, thereby leaving a gap G between the punch head and the punch carrier.

On the other hand, the magnets are reliably supported by the carousel 36 which, as shown, unlike the punch carrier 14, does not move axially in the multiple punch unit 10, and hence consistently protects the work-piece against damages caused by the punch tip.

In another alternative embodiment of the invention (not shown), the set of magnets 48 is joined to a non-rotatable element, such as the guide seat 16, designated by numeral 16B, whereby each magnet is located within a magnetic circuit to support each punch, regardless of which punch is selected for use as a punching element.

In this case, as the punch striker is lowered, it overcomes the upward retention force provided by the magnet 16B.

Otherwise, the magnetic punches may move downwards when the punch carrier is lowered, e.g. by being connected with the punch carrier 14, but still prevent the inactive punches from being lowered, by applying a magnetic flux to a non-descending portion of the unit such as the carousel 36, in this example with no magnet mounted therein.

In a third, less preferred, embodiment of the invention, the magnets are not mounted to the carousel 36 but to the heads of the punches 12, as shown in 12c (FIG. 2) or anywhere in the selected punch, to provide magnetic attraction by a portion of the unit which, like the carousel, is constrained, to prevent it to axially slide on the apparatus.

In this example, the carousel 36 and its magnets might be replaced by a ferromagnetic material.

Magnets of other shapes may be also used, such as cylindrical magnets, toroidal magnets, multipole magnets or electromagnets.

The invention was found to fulfill the intended objects.

The invention so conceived is susceptible to a number of changes and variants within the inventive concept.

Furthermore, all the details may be replaced by other technically equivalent parts.

In practice, any materials, shapes and sizes may be used as needed, without departing from the scope of the following claims.

The invention claimed is:

1. A multiple punch apparatus for punch presses configured to prevent unintended damage to a work-piece, the apparatus comprising:
a housing having a plurality of separate punches that comprise an inactive punch and an active punch,
wherein each inactive punch is supported in an elevated position by retention magnet means having flux lines positioned to extend into each inactive punch when the active punch is positioned for being driven into engagement with a work-piece.

2. The multiple punch apparatus according to claim 1, wherein the retention magnet means comprise a permanent magnet.

3. The multiple punch apparatus according to claim 1, wherein there are a plurality of inactive punches, a plurality of magnets movably being supported for shifting from a position aligned with one of the separate punches to a position aligned with a different one of the separate punches.

4. The multiple punch apparatus according to claim 1, wherein the retention magnet means are supported circumferentially on a carousel and the carousel is mounted for rotation about a common rotation axis together with a punch striker, such that the striker is rotatably indexed from an aligned position with one of the separate punches to a different punch selected for driving into contact with the work-piece.

5. The multiple punch apparatus according to claim 4, wherein the retention magnet means comprise:
a magnet assembly including a centrally located permanent magnet, having a first magnetic pole located proximate a top surface of a punch located adjacent thereto; and
a magnetically permeable ferromagnetic housing having a wall enclosing the magnet with an upper end positioned such that flux lines pass from the magnet at an upper end through a top portion of the housing, to form a magnetic circuit back through the wall of the housing, through the punch to the first magnetic pole of the magnet.

6. The multiple punch apparatus according to claim 5, wherein a top end of the punch is alternatively in contact with the magnet or spaced from a lower face thereof.

7. The multiple punch apparatus according to claim 5, wherein there is a space that surrounds the magnet between the magnet and the permeable ferromagnetic housing and the space is occupied by a non-ferromagnetic separator.

8. The multiple punch apparatus according to claim 7, wherein the magnet is a permanent magnet that is supported concentrically within the housing by the non-ferromagnetic separator.

9. The multiple punch apparatus according to claim 5, wherein the magnet assembly is secured to the carousel that is rotatably mounted upon a punch assembly, the carousel being received so as to prevent axial sliding movements thereof along a punching axis of the punch assembly to support one of the several punches and to prevent unintended damage to the work-piece.

10. The multiple punch apparatus according to claim 9, wherein the punch is slidably supported upon a punch carrier for axial sliding movement along the punching axis, the punch carrier being lowered during a punching operation to thereby form a gap between the one of the several punches while the punch carrier and the one of the several punches remain magnetically supported by the magnet assembly as the punch carrier is lowered away from a punch supporting position.

11. The multiple punch apparatus according to claim 1, wherein the retention magnetic means comprise a magnetic assembly selected from the group consisting of a magnetically permeable housing surrounding a permanent magnet spaced therein, a cylindrical magnet, a rectangular magnet, a toroidal magnet or a multiple pole magnet.

12. A punching apparatus to be used in punching presses, the punching apparatus comprising:
an upper rotatable section rotating about a vertical central axis relative to a lower non-rotatable section;
a pair of punches mounted for reciprocation in the lower non-rotatable section along axes that are spaced outwardly from a central axis;
a punch carousel as a part of the rotatable section that has retention magnetic means thereon, the carousel being positioned for selective alignment with each of the punches responsive to rotation of the punch carousel;
a punch striker mounted for reciprocation in the rotatable section for driving a selected one of the punches axially to an operating position into engagement with a work-piece while each of another of the punches is held in a retracted position by at least one of the retention magnetic means, and
biasing magnetic means that bias the selected one of the punches to a retracted position for withdrawing the selected one of the punches from the work-piece, whereby each non-selected punch is held in an elevated position by magnetic attraction to prevent unintended contact between each punch that is not in use and the work-piece.

13. The punching apparatus according to claim 12, wherein the retention magnetic means comprise at least a part of a magnet assembly including:
a housing formed from magnetically permeable ferromagnetic material;
a magnet mounted in the housing in a laterally spaced relationship; and
a non-ferromagnetic substance positioned between the magnet and the housing.
